(19) United States
(12) Patent Application Publication
(10) Pub. No.: US 2023/0211670 A1
(43) Pub. Date: Jul. 6, 2023

(54) NON-CONTACT POWER SUPPLY DEVICE, CONVEYING SYSTEM, AND PARAMETER SETTING METHOD

(71) Applicant: MURATA MACHINERY, LTD., Kyoto-shi, Kyoto (JP)

(72) Inventor: Hiroyasu TOMITA, Inuyama-shi (JP)

(21) Appl. No.: 18/008,693

(22) PCT Filed: Feb. 24, 2021
(86) PCT No.: PCT/JP2021/006911

§ 371 Date: Dec. 7, 2022

(30) Foreign Application Priority Data
Jun. 29, 2020 (JP) 2020-111818

(51) Int. Cl. B60L 5/00; H02J 50/12; H02M 7/5387; B60L 5/38; B60M 7/00

(52) U.S. Cl. CPC B60L 5/005; H02J 50/12; H02M 7/53871; B60L 5/38; B60M 7/00

(57) ABSTRACT

A non-contact power supply device includes an inverter to convert power supplied from a power supply into a predetermined AC power, feeders provided on a track rail to transmit the AC power to a ceiling conveyor, a filter circuit including a reactor and a capacitor, and a controller configured or programmed to perform power control of the AC power that is to be supplied to the feeders. The controller is configured or programmed to obtain a current value output from the inverter while changing a switching frequency of switches of the inverter in a state in which a current having a predetermined value flows through the feeders, and to set and output a reactor value of the reactor and a capacitance value of the capacitor based on the switching frequency at which the current value is minimum.

### BACKGROUND OF THE INVENTION

### 1. Field of the Invention

The present invention relates to a non-contact power supply device, a conveying system, and a parameter setting method.

### 2. Description of the Related Art

As a conventional non-contact power supply device, the device described in, for example, Japanese Unexamined Patent Publication No. 2018-7509, is known. The non-contact power supply device described in Japanese Unexamined Patent Publication No. 2018-7509 includes a feeding unit that transmits power to a power receiving device in a non-contact manner, an inverter that generates and supplies transmitting power of alternating current (AC) to the feeding unit, a filter circuit provided between the inverter and the feeding unit, and a control device that controls the inverter.

### SUMMARY OF THE INVENTION

In a non-contact power supply device, when the inverter current flowing to an inverter is large, a large amount of current flows through switches of the inverter, which can cause overcurrent, heat generation, or the like. Therefore, in the non-contact power supply device, in order to suppress the occurrence of such phenomena, values of a reactor and a capacitor of a filter circuit provided between the inverter and the feeder are set such that the inverter current is reduced.

A reactor value of the reactor and a capacitance value of the capacitor are adjusted manually by an operator. The reactor value and the capacitance value depend on inductance of a track rail, and thus are set based on the inductance of the track rail. The inductance of the track rail is derived from design details of the track rail. However, an error can occur between the inductance derived from design details and the inductance of the track rail that is actually installed. Therefore, the operator sets the reactor value and the capacitance value that minimize the inverter current by changing the reactor value and the capacitance value such that the inverter current is reduced, repeating trial and error. Thus, setting the reactor value and the capacitance values takes labor and time.

Preferred embodiments of the present invention provide non-contact power supply devices, conveying systems, and parameter setting methods, each capable of performing parameter adjustment efficiently.

A non-contact power supply device according to one aspect of a preferred embodiment of the present invention is a non-contact power supply device for supplying power to a traveling vehicle traveling on a track rail in a non-contact manner, the non-contact power supply device including an inverter to convert power supplied from a power supply into a predetermined AC power, the inverter including a plurality of switches, a feeder provided on the track rail to transmit the AC power to the traveling vehicle, a filter circuit provided between the inverter and the feeder and including a reactor and a capacitor, and a controller configured or programmed to perform power control of the AC power that is to be supplied to the feeder, in which the controller is configured or programmed to obtain a current value output from the inverter while changing a switching frequency of the switches of the inverter in a state in which a current having a predetermined value flows through the feeder, and to set and output a reactor value of the reactor and a capacitance value of the capacitor based on the switching frequency at which the current value is a minimum value.

In a non-contact power supply device according to one aspect of a preferred embodiment of the present invention, the controller is configured or programmed to obtain the current value output from the inverter while changing the switching frequencies of the plurality of switches, and to set and output the reactor value of the reactor and the capacitance value of the capacitor based on the switching frequency at which the current value is the minimum value. Thus, in the non-contact power supply device, the reactor value of the reactor and the capacitance value of the capacitor at which the current value is reduced or reduced are set and output. This allows the operator to easily adjust the reactor value and the capacitance value by checking the reactor value of the reactor and the capacitance value of the capacitor. Therefore, in the non-contact power supply device, parameter adjustment can be efficiently performed.

In one preferred embodiment, the controller may set the predetermined value of the current that flows through the feeder to a value below current required to drive traveling of the traveling vehicle. In this configuration, it is possible to perform parameter adjustment without affecting the traveling vehicle.

In one preferred embodiment, the controller may change the switching frequency in steps within a predetermined range. In this configuration, it is possible to appropriately obtain a minimum value of a current value output from the inverter.

In one preferred embodiment, the controller may have a table in which the switching frequency is associated with the reactor value of the reactor and the capacitance value of the capacitor, and may obtain the reactor value of the reactor and the capacitance value of the capacitor from the table based on the switching frequency at which the current value is the minimum value. In this configuration, it is possible to promptly obtain and output the reactor value and the capacitance value.

A conveying system according to one aspect of a preferred embodiment of the present invention includes the above-described non-contact power supply device, and a traveling vehicle to travel by receiving power transmitted from the non-contact power supply device.

A conveying system according to one aspect of a preferred embodiment of the present invention includes the above-described non-contact power supply device. Therefore, in the conveying system, it is possible to efficiently perform parameter adjustment in the non-contact power supply device.

A parameter setting method according to one aspect of a preferred embodiment of the present invention is a parameter setting method for setting parameters in a non-contact power supply device for supplying power to a traveling vehicle traveling on a track rail in a non-contact manner, the non-contact power supply device including an inverter to convert power supplied from a power supply into a predetermined AC power, the inverter including a plurality of switches, a feeder provided on the track rail to transmit the AC power to the traveling vehicle, and a filter circuit provided between the inverter and the feeder and including a reactor and a capacitor, the parameter setting method including obtaining a current value output from the inverter while changing the switching frequency of the switches of the inverter in a state in which a current having a predetermined value flows through the feeder, and setting and outputting a reactor value of the reactor and a capacitance value of the capacitor based on the switching frequency at which the current value is a minimum value.

In a parameter setting method according to one aspect of a preferred embodiment of the present invention, the current value output from the inverter is obtained while changing the switching frequency of the switches, and the reactor value of the reactor and the capacitance value of the capacitor are set and output based on the switching frequency at which the current value is the minimum value. Thus, in the parameter setting method, the reactor value of the reactor and the capacitance value of the capacitor at which the current value is reduced or reduced are set and output. This allows the operator to easily adjust the reactor value and the capacitance value by checking the reactor value of the reactor and the capacitance value of the capacitor. Therefore, in the parameter setting method, parameter adjustment can be efficiently performed.

According to preferred embodiments of the present invention, parameter adjustment can be efficiently performed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram schematically illustrating an example of a conveying system.

FIG. 2 is a diagram illustrating a configuration of a non-contact power supply device.

FIG. 3 is a diagram illustrating a ceiling conveyor.

FIGS. 4A to 4C are graphs showing a relationship between current, inductance, and frequency.

### DETAILED DESCRIPTION OF THE PREFERRED EMBODIMENTS

Preferred embodiments according to the present invention will now be described in detail with reference to the attached drawings. In description of the drawings, like or equivalent elements are designated by like reference signs, and duplicate description is omitted.

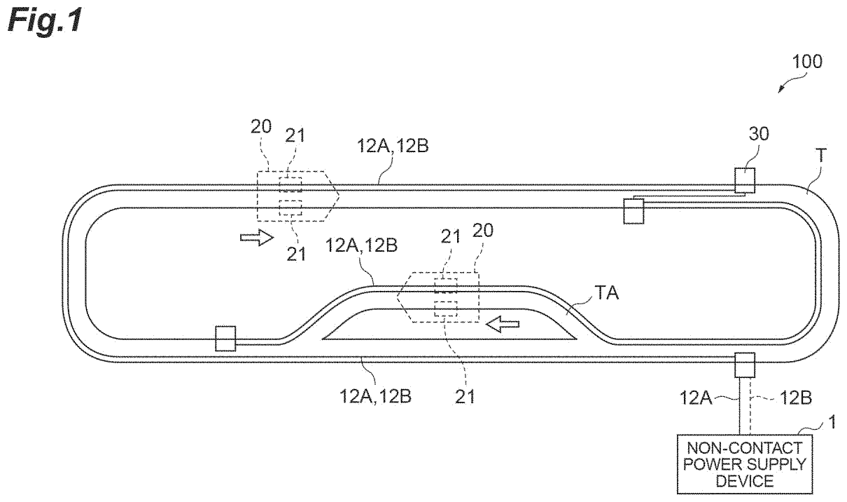

As illustrated in FIG. 1, a conveying system 100 includes a non-contact power supply device 1 and a ceiling conveyor (traveling vehicle) 20. The conveying system 100 is a system configured to convey articles (not illustrated) using the ceiling conveyor 20 capable of traveling along a track rail T. In the conveying system 100, power is supplied to the ceiling conveyor 20 in a non-contact manner from feeders 12A and 12B provided on the track rail T. The ceiling conveyor 20 drives traveling of the ceiling conveyor 20 or various devices provided in the ceiling conveyor 20 with the supplied power.

The ceiling conveyor 20 includes, for example, a ceiling suspended type crane, an overhead hoist transfer (OHT), and the like. Articles include, for example, containers configured to store a plurality of semiconductor wafers, containers configured to store glass substrates, reticle pods, general components, and the like. The following describes the conveying system 100 as an example in which the ceiling conveyor 20 travels, for example, in a factory, along the track rail T installed on a ceiling of the factory.

The track rail T is, for example, an orbiting track. The feeders 12A and 12B are supplied with power from the non-contact power supply device 1. The feeders 12A and 12B are disposed below the track rail T and on at least one of a right side and a left side with respect to the center of the track in a traveling direction of the ceiling conveyor 20. Note that because the feeder 12B is provided below the feeder 12A, the feeder 12B is in a state of being laid below the feeder 12A in FIG. 1.

The feeders 12A and 12B can be rearranged with respect to the track rail T by a switching unit 30. The feeders 12A and 12B are disposed on the left side of the track rail T in an initial area connected to the non-contact power supply device 1. As the ceiling conveyor 20 travels along the track rail T in the traveling direction, the feeders 12A and 12B are switched in disposition from the left side to the right side of the track rail T by the switching unit 30. The feeders 12A and 12B being disposed on the right side of the track rail T allows power to be continuously supplied also when the ceiling conveyor 20 travels on a branch line TA that branches off from the track rail T, as illustrated in FIG. 1.

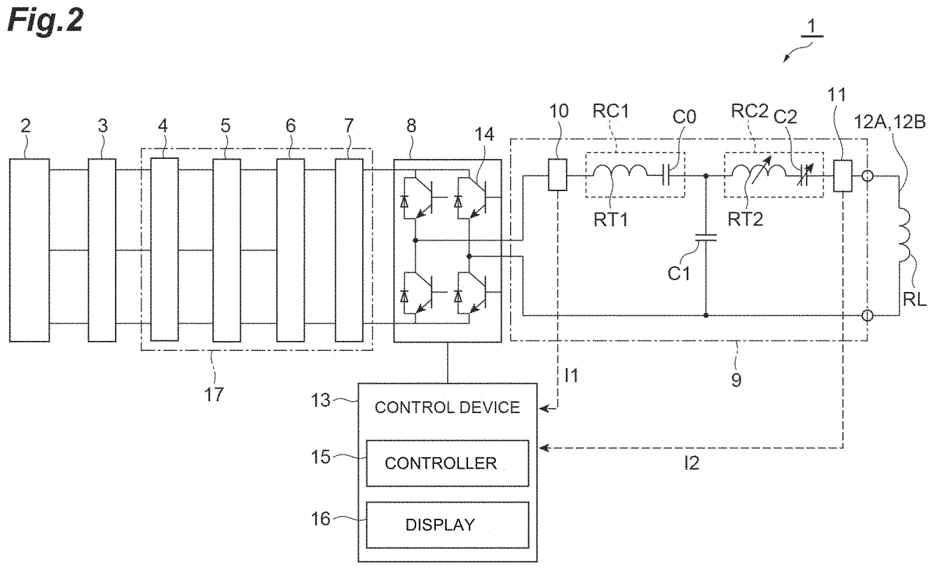

The non-contact power supply device 1 supplies power to the ceiling conveyor 20 in a non-contact manner. As illustrated in FIG. 2, the non-contact power supply device 1 includes a power supply 2, a wiring breaker 3, a noise filter 4, a power factor improvement device 5, a rectifier 6, a smoother 7, an inverter 8, a filter circuit 9, a first current sensor 10, a second current sensor 11, feeders 12A and 12B, and a control device 13. The noise filter 4, the power factor improvement device 5, the rectifier 6, and the smoother 7 define a power converter 17.

The power supply 2 is an AC power supply, such as a commercial power supply, and supplies an AC power (three-phase 200 V). A frequency of the AC power is, for example, 50 Hz or 60 Hz. The wiring breaker 3 opens an electrical circuit when an overcurrent flows. The noise filter 4 removes noise from the AC power. The noise filter 4 includes a capacitor, for example. The power factor improvement device 5 improves the power factor by bringing an input current closer to a sine wave. The power factor improvement device 5 includes a reactor, for example.

The rectifier 6 converts the AC power supplied from the power supply 2 (power factor improvement device 5) into DC power. The rectifier 6 includes a rectifier element, such as a diode, for example. The rectifier 6 may be configured by a switch such as a transistor. The smoother 7 smooths the DC power converted in the rectifier 6. The smoother 7 includes an electrolytic capacitor, for example. The power converter 17 may perform a step-up/step-down function.

The inverter 8 converts the DC power output from the smoother 7 into an AC power and outputs it to the filter circuit 9. A frequency of the AC power is, for example, about 8.99 kHz. The inverter 8 changes the magnitude of the AC power output to the filter circuit 9 by changing the switching frequency based on a control signal output from the control device 13. The inverter 8 has a plurality of switches 14. The switches 14 are elements capable of switching electrical opening and closing. For example, metal oxide semiconductor field effect transistors (MOSFETs), insulated gate bipolar transistors (IGBTs), bipolar transistors, and the like are used as the switches 14.

The filter circuit 9 is provided between the inverter 8 and the feeders 12A and 12B. The filter circuit 9 suppresses harmonic noise. The filter circuit 9 includes a reactor RT1, a capacitor C0, a capacitor C1, a reactor RT2, and a capacitor C2.

The reactor RT1 and the capacitor C0 are connected in series to define a first resonant circuit RC1. The reactor RT2 and the capacitor C2 are connected in series to define a second resonant circuit RC2. The first resonant circuit RC1 and the second resonant circuit RC2 are connected in series.

The reactor RT2 is a variable reactor capable of changing (adjusting) a reactor value thereof. The capacitor C2 is a variable capacitor capable of changing a capacitance value thereof. The reactor value (parameter) of the reactor RT2 and the capacitance value (parameter) of the capacitor C2 are set (adjusted), for example, by an operator when equipment of the conveying system 100 is installed. The capacitor C1 is connected in parallel to the first resonant circuit RC1 and the second resonant circuit RC2.

The first current sensor 10 detects a current I1 (inverter current) output from the inverter 8, that is, flowing through the inverter 8. The first current sensor 10 outputs a first current signal indicating the detected current I1 to the control device 13. The second current sensor 11 detects a current I2 (feeding current) of the AC power passing through the second resonant circuit RC2. The second current sensor 11 outputs a second current signal indicating the detected current I2 to the control device 13.

The feeders 12A and 12B include coils to transfer power in a non-contact manner to the power receiving unit 21 of the ceiling conveyor 20. The feeders 12A and 12B are, for example, litz wires formed by including a plurality of bundles of tens to hundreds of copper wires twisted together, further twisting the bundles together, and covering the outer circumference of the twisted bundles by a tube made of, for example, an insulating material. The feeders 12A and 12B generate magnetic flux when the AC power is supplied from the filter circuit 9. The feeders 12A and 12B have an inductance RL.

The control device 13 controls the operation of the inverter 8. The control device 13 is a computer system or a processor implemented in an integrated circuit. The control device 13 includes a central processing unit (CPU), a read only memory (ROM), a random access memory (RAM), and the like, and an input/output interface and the like. The ROM stores various programs or data.

The control device 13 includes a controller 15 and a display 16. The control device 13 is connected to the first current sensor 10 and the second current sensor 11 of the filter circuit 9. The control device 13 inputs the first current signal and the second current signal output from the first current sensor 10 and the second current sensor 11, respectively.

The controller 15 controls the magnitude of the AC power supplied to the feeders 12A and 12B by controlling the inverter 8, thus controlling the magnitude of power supplied to the ceiling conveyor 20. In the present preferred embodiment, the power control is performed using phase shift control. In the phase shift control, power control parameters are changed to control the magnitude of an AC power. The controller 15 implements phase shift control to change the magnitude (frequency) of the AC power by changing an ON period of the inverter 8. The controller 15 uses drive signals to the plurality of switches 14 of the inverter 8 to adjust the switching frequency of each switch 14, and change the ON period of each switch 14. The power control parameter in the phase shift control is the ON period of each switch 14 of the inverter 8.

The controller 15 performs power control so that the value of power transmitted to the ceiling conveyor 20 is a target value based on the first current signal and the second current signal output from the first current sensor 10 and the second current sensor 11, respectively.

The controller 15 calculates the reactor value of the reactor RT2 and the capacitance value of the capacitor C2 upon receiving a request from the operator when the equipment of the conveying system 100 is provided. The reactor value of the reactor RT2 and the capacitance value of the capacitor C2 are set to constant values in an initial (unadjusted) state. The reactor value of the reactor RT2 and the capacitance value of the capacitor C2 depend on the inductance RL of the feeders 12A and 12B. Therefore, a constant value is predetermined based on the inductance RL based on the design of the feeders 12A and 12B.

The controller 15 sets the reactor value of the reactor RT2 and the capacitance value of the capacitor C2 at which the current I1 indicated by the first current signal output from the first current sensor 10 is reduced or reduced. The controller 15 obtains the current I1 output from the inverter 8 while changing the switching frequency of the switches 14 of the inverter 8 in a state in which current I2 having a predetermined value flows through the feeders 12A and 12B, and sets and outputs the reactor value of the reactor RT2 and the capacitance value of the capacitor C2 based on the switching frequency at which the current I1 is the minimum value.

The controller 15 controls the inverter 8 such that the current I2 detected at the second current sensor 11 is a predetermined value (for example, 12 A). The predetermined value is set to a value below drive current (for example, 75 A) at which the ceiling conveyor 20 drives traveling (start traveling). The controller 15 changes the switching frequency of the switches 14 of the inverter 8 in steps within a predetermined range in a state in which the current I2 has a predetermined value. The predetermined range includes a frequency of the AC power (e.g., about 8.99 kHz). In the present preferred embodiment, the controller 15 changes the switching frequency within a range from about 5 kHz to about 15 kHz in approximately 0.1 kHz steps, for example, to obtain the current I1 based on the first current signal output from the first current sensor 10. The controller 15 stores the current I1 with respect to the switching frequency. The controller 15 obtains the switching frequency at which the current I1 is reduced or reduced in a plurality of values of the stored current I1.

The controller 15 sets the reactor value of the reactor RT2 and the capacitance value of the capacitor C2 based on the switching frequency at which the current I1 is reduced. Specifically, the controller 15 refers to a table to obtain the reactor value of the reactor RT2 and the capacitance value of the capacitor C2 based on the switching frequency at which the current value is the minimum value. The controller 15 has a table in which the switching frequency, the inductance RL, the reactor value of the reactor RT2, and the capacitance value of the capacitor C2 are associated one another.

Based on the switching frequency at which the current I1 is reduced, the controller 15 refers to the table to obtain the reactor value of the reactor RT2 and the capacitance value of the capacitor C2. The controller 15 outputs setting information indicating the obtained reactor value of the reactor RT2 and the capacitance value of the capacitor C2 to the display 16.

The display 16 performs display based on the setting information output from the controller 15. The display 16 is, for example, a segment display, or the like. The display 16 displays the reactor value of the reactor RT2 and the capacitance value of the capacitor C2 (set values) based on the setting information. The operator adjusts the reactor RT2 and the capacitor C2 based on the set values displayed on the display 16.

The ceiling conveyor 20 travels along the track rail T to convey articles. The ceiling conveyor 20 is capable of transferring articles. The number of units of the ceiling conveyor 20 included in the conveying system 100 is not limited to a particular number, and may be two or more.

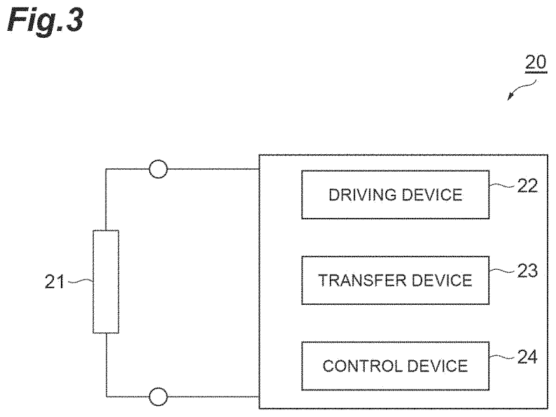

As illustrated in FIG. 3, the ceiling conveyor 20 includes a power receiving unit 21, a driving device 22, a transfer device 23, and a control device 24.

The power receiving unit 21 receives power transmitted from the non-contact power supply device 1 in a non-contact manner. The power receiving unit 21 includes a coil configured to receive power. Interlinkage of the magnetic flux generated by the feeders 12A and 12B with the power receiving unit 21 generates an AC power in the power receiving unit 21. The power receiving unit 21 supplies the AC power to the driving device 22 and the transfer device 23. A capacitor and a reactor may be connected between the power receiving unit 21 and the driving device 22, and between the power receiving unit 21 and the transfer device 23.

The driving device 22 rotates and drives a plurality of wheels (not illustrated). The driving device 22 uses, for example, an electric motor or a linear motor, or the like, and uses power supplied from the power receiving unit 21 as power for driving.

The transfer device 23 is capable of holding and accommodating articles to be transferred, and transfers the articles. The transfer device 23 includes, for example, a side-unloading mechanism that holds and protrudes articles, an elevating mechanism that moves the articles downward, and the like. By driving the side-unloading mechanism and the elevating mechanism, the transfer device 23 delivers and receives the articles to and from a load port of a storage device such as a stocker or the like that is a transfer destination or a load port of a processing device. The transfer device 23 uses power supplied by the power receiving unit 21 as power for driving.

The control device 24 controls the driving device 22 and the transfer device 23. The control device 24 uses the power supplied by the power receiving unit 21 as the power for driving.

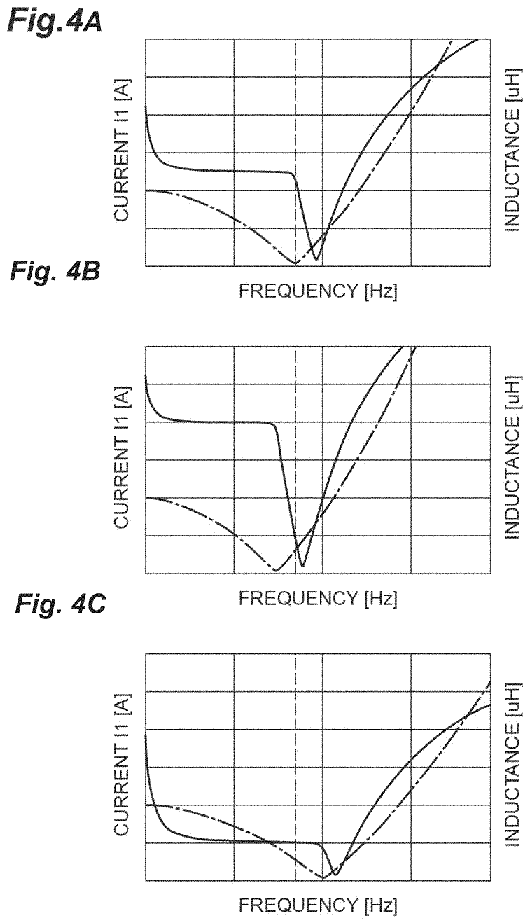

In FIGS. 4A to 4C, a vertical axis indicates current I1 [A] and inductance [uH], and a horizontal axis indicates frequencies [kHz]. In FIGS. 4A to 4C, the current I1 is shown as a dotted line and the inductance RL as a solid line. FIG. 4A shows measurement results when the reactor value and the capacitance value of the second resonant circuit RC2 are set appropriately for the inductance RL of the feeders 12A and 12B. FIGS. 4B and 4C show measurement results when the reactor value and the capacitance value of the second resonant circuit RC2 are not set appropriately for the inductance RL of the feeders 12A and 12B.

As illustrated in FIG. 4A, if the reactor value and the capacitance value of the second resonant circuit RC2 are set appropriately for the inductance RL of the feeders 12A and 12B, the current I1 is reduced at the frequency of the inverter 8 (e.g., about 8.99 kHz, indicated as dashed line in FIG. 4A). As illustrated in FIG. 4B, when the values of the inductance RL of the feeders 12A and 12B are large relative to the reactor value and the capacitance value of the second resonant circuit RC2, the current I1 is reduced at a frequency lower than that of the inverter 8 (e.g., about 8.99 kHz). As illustrated in FIG. 4C, when the values of the inductance RL of the feeders 12A and 12B are small relative to the reactor value and the capacitance value of the second resonant circuit RC2, the current I1 is reduced at a frequency higher than that of the inverter 8 (e.g., about 8.99 kHz).

As illustrated in FIGS. 4B and 4C, if the reactor value and the capacitance value of the second resonant circuit RC2 are not set appropriately for the inductance RL of the feeders 12A and 12B, the current I1 is not minimum for the frequency of the inverter 8. When the current I1 flowing to the inverter is large, more current flows to the switches 14 of the inverter 8, which can cause overcurrent, heat generation, and the like. Therefore, in order to reduce or prevent the occurrence of such phenomena, the non-contact power supply device 1 is required to set the reactor value of the reactor RT2 and the capacitance value of the capacitor C2 such that the current I1 is reduced.

In the non-contact power supply device 1 of the conveying system 100 (parameter setting method) according to the present preferred embodiment, the controller 15 obtains the current value of the current I1 output from the inverter 8 while changing the switching frequency of the switches 14, and sets and outputs the reactor value of the reactor RT2 and the capacitance value of the capacitor C2 based on the switching frequency at which the current value is the minimum value. In this way, in the non-contact power supply device 1, the reactor value of the reactor RT2 and the capacitance value of the capacitor C2 are set and output such that the current value of the current I1 is reduced. This allows the operator to easily adjust the reactor and capacitance values by checking the reactor value of the reactor RT2 and the capacitance value of the capacitor C2. Therefore, in the non-contact power supply device 1, parameter adjustment can be efficiently performed.

In the non-contact power supply device 1, the controller 15 sets the predetermined value of the current flowing in the feeders 12A and 12B to a value below the current required to drive traveling of the ceiling conveyor 20. In this configuration, it is possible to perform parameter adjustment without affecting the ceiling conveyor 20.

In the non-contact power supply device 1 according to the present preferred embodiment, the controller 15 changes the switching frequency in steps within a predetermined range. In this configuration, it is possible to appropriately obtain a minimum value of the current I1 output from the inverter 8.

The non-contact power supply device 1 according to the present preferred embodiment includes a table in which the switching frequency is associated with the reactor value of the reactor RT2 and the capacitance value of the capacitor C2, and based on the switching frequency at which the current value is the minimum value, obtains the reactor value of the reactor RT2 and the capacitance value of the capacitor C2 from the table. In this configuration, it is possible to promptly obtain and output the reactor value and the capacitance value.

Although preferred embodiments according to the present invention have been described above, the present invention is not limited to the above-described preferred embodiments, and various modifications can be made within the scope not departing from the gist of the present invention.

In the above-described preferred embodiments, an example in which the traveling vehicle is the ceiling conveyor 20 is described. However, a moving body is not limited to a ceiling conveyor, but can be any traveling vehicle traveling on the track rail T. For example, the traveling vehicle may be a floor conveyor (floor traveling vehicle). If the traveling vehicle is a floor conveyor, track rails are laid on a floor.

In the above-described preferred embodiments, an example in which the controller 15 references the table based on the switching frequency to obtain and set the reactor value of the reactor RT2 and the capacitance value of the capacitor C2 is described. However, the controller 15 may calculate and output the reactor value of the reactor RT2 and the capacitance value of the capacitor C2 by calculation.

In the above-described preferred embodiments, an example in which the controller 15 changes the switching frequency by about 0.1 kHz in the range from about 5 kHz to about 15 kHz and obtains the current I1 based on the first current signal output from the first current sensor 10 is described. However, the range of the switching frequency, or the like changed by the controller 15 is not limited to the above-described values, but may be set as appropriate.

In the above-described preferred embodiments, an example in which the controller that performs the power control of the AC power supplied to the feeders 12A and 12B is the control device 13 that controls the operation of the inverter 8 is described. However, the controller is not limited to a device that controls the inverter 8, but may be a device that comprehensively controls the non-contact power supply device 1, for example.

In the above-described preferred embodiments, an example in which the reactor value of the reactor RT2 and the capacitance value of the capacitor C2 are displayed on the display 16 of the control device 13 is described. However, the output form of the reactor value of the reactor RT2 and the capacitance value of the capacitor C2 is not limited to this and may be output by voice, for example. The display may be provided separate from the control device 13. For example, the display may be a tablet or other device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled)

7. A non-contact power supply device for supplying power to a traveling vehicle traveling on a track rail in a non-contact manner, the non-contact power supply device comprising:
an inverter to convert power supplied from a power supply into a predetermined AC power, the inverter including a plurality of switches;
a feeder provided on the track rail to transmit the AC power to the traveling vehicle;
a filter circuit provided between the inverter and the feeder and including a reactor and a capacitor; and
a controller configured or programmed to perform power control of the AC power that is to be supplied to the feeder; wherein
the controller is configured or programmed to obtain a current value output from the inverter while changing a switching frequency of the switches of the inverter in a state in which a current having a predetermined value flows through the feeder, and to set and output a reactor value of the reactor and a capacitance value of the capacitor based on the switching frequency at which the current value is a minimum value.

8. The non-contact power supply device according to claim 7, wherein the controller is configured or programmed to set the predetermined value of the current that flows through the feeder to a value below a current required to drive traveling of the traveling vehicle.

9. The non-contact power supply device according to claim 7, wherein the controller is configured or programmed to change the switching frequency in steps within a predetermined range.

10. The non-contact power supply device according to claim 7, wherein the controller is configured or programmed to include a table in which the switching frequency is associated with the reactor value of the reactor and the capacitance value of the capacitor, and to obtain the reactor value of the reactor and the capacitance value of the capacitor from the table based on the switching frequency at which the current value is the minimum value.

11. A conveying system comprising:
the non-contact power supply device according to claim 7; and
a traveling vehicle to travel by receiving power transmitted from the non-contact power supply device.

12. A parameter setting method for setting parameters in a non-contact power supply device for supplying power to a traveling vehicle traveling on a track rail in a non-contact manner, the non-contact power supply device including an inverter to convert power supplied from a power supply into a predetermined AC power, the inverter including a plurality of switches, a feeder provided on the track rail to transmit the AC power to the traveling vehicle, and a filter circuit provided between the inverter and the feeder and including a reactor and a capacitor, the parameter setting method comprising:
obtaining a current value output from the inverter while changing a switching frequency of the switches of the inverter in a state in which a current having a predetermined value flows through the feeder; and
setting and outputting a reactor value of the reactor and a capacitance value of the capacitor based on the switching frequency at which the current value is a minimum value.
